(19) United States
(12) Patent Application Publication
(10) Pub. No.: US 2023/0282961 A1
(43) Pub. Date: Sep. 7, 2023

(54) Antenna and Communication Device

(71) Applicant: Huawei Technologies Co., Ltd., Shenzhen (CN)

(72) Inventors: Min Yu, Chengdu (CN); Rujun Luo, Chengdu (CN); Xin Luo, Chengdu (CN)

(21) Appl. No.: 18/177,440

(22) Filed: Mar. 2, 2023

(30) Foreign Application Priority Data
Mar. 7, 2022 (CN) 202210215117.6
May 6, 2022 (CN) 202210486984.3

(51) Int. Cl. H01Q 1/22; H01Q 1/48; H01Q 19/10; H01Q 9/04

(52) U.S. Cl. CPC H01Q 1/2291; H01Q 1/48; H01Q 19/10; H01Q 9/045

(57) ABSTRACT

An antenna and a communication device are disclosed. The antenna may be used in an access point. The antenna specifically includes a first conductor sheet and a feed point. The first conductor sheet includes at least two cavities. The at least two cavities are connected through a gap. A circumference of each of the at least two cavities approaches a wavelength corresponding to an operating frequency band of the antenna. The feed point is connected to the gap. The antenna with a simple structure and a small size may generate two beams. Therefore, an access point disposed with the antenna may generate strong wireless signals in two directions, and the wireless signal may cover an adjacent room. In this way, there is no need to deploy an access point in each room, and a quantity of wireless access points to be deployed is reduced.

### CROSS-REFERENCE TO RELATED APPLICATION

This application claims priority to Chinese Patent Application No. 202210215117.6, filed on Mar. 7, 2022, and Chinese Patent Application No. 202210486984.3, filed on May 6, 2022. The aforementioned patent applications are hereby incorporated by reference in their entireties.

### TECHNICAL FIELD

This application relates to the communications field, and in particular, to an antenna and a communication device.

### BACKGROUND

An access point (access point, AP) is configured to convert a wired network into a wireless network.

APs usually use omnidirectional antennas to transmit wireless signals. When the APs are deployed indoors, for example, in a scenario with a plurality of high-density rooms, strength of the wireless signals generated by the omnidirectional antennas is greatly attenuated by walls that partition the rooms. Therefore, the APs need to be separately deployed in all the rooms to meet a requirement for wireless signal strength in each room.

However, a large quantity of APs are deployed consequently.

### SUMMARY

This application provides an antenna, to reduce a quantity of access points to be deployed. This application further provides a corresponding communication device.

According to a first aspect, an antenna is provided, including a first conductor sheet and a feed point. The first conductor sheet includes at least two cavities, and the at least two cavities are connected through a gap. A circumference of each of the at least two cavities approaches a wavelength corresponding to an operating frequency band of the antenna. The feed point is connected to the gap.

That the circumference of the cavity approaches the wavelength corresponding to the operating frequency band of the antenna means that the circumference of the cavity is approximately equal to the wavelength corresponding to the operating frequency band of the antenna. When the circumference of the cavity approaches the wavelength corresponding to the operating frequency band of the antenna, the feed point may generate a standing wave current on the first conductor sheet through the gap. The standing wave current oscillates along the first conductor sheet, and maximum values of the standing wave current (where corresponding standing wave currents are referred to as maximum standing wave currents for short) are generated at two ends of the cavity, and have a same direction. Because maximum standing wave currents in the two cavities near the gap side are close to each other, the maximum standing wave currents may be considered as an equivalent array satisfying binomial distribution of “1, 2, 1”, that is, an amplitude of an oscillator of the antenna conforms to binomial distribution. Based on an array theory, after the antenna is powered on at the feed point, zero points may be formed at two ends of the first conductor sheet in a direction along the gap, to construct dual beams. The antenna with a simple structure and a small size may generate two beams. Therefore, strong wireless signals can be generated in two directions in an access point provided with the antenna. The wireless signals can cover adjacent rooms, so that access points do not need to be deployed in all rooms, and a quantity of access points to be deployed is reduced.

In a possible implementation of the first aspect, a deviation between the circumference of the cavity and the wavelength corresponding to the operating frequency band of the antenna is less than 20%.

In this possible implementation, the deviation between the circumference of the cavity and the wavelength corresponding to the operating frequency band of the antenna is specifically limited to less than 20%, so that the antenna can generate dual beams. This improves implementability of this solution.

In a possible implementation of the first aspect, the first conductor sheet includes at least four cavities. The feed point is connected to a middle gap, and the middle gap is a gap in the middle of a plurality of gaps connecting the at least four cavities.

In this possible implementation, a quantity of cavities in the first conductor sheet is increased, so that a transverse diameter of the antenna may be increased, a distance between two zero points formed on the first conductor sheet also becomes longer, dual beams generated by the antenna become narrower, and beam energy is more concentrated. In this way, a beam gain of the antenna is improved.

In a possible implementation of the first aspect, the antenna further includes a second conductor sheet. The second conductor sheet includes at least two cavities that are connected through a gap, and a circumference of each of the at least two cavities approaches the wavelength corresponding to the operating frequency band of the antenna. Gaps are connected by using a feed network.

In this possible implementation, the second conductor sheet is added, so that the transverse diameter of the antenna is increased. In this way, a quantity of beams can be changed, and the antenna may be arranged in more manners, and may be used in more deployment scenarios.

In a possible implementation of the first aspect, the antenna further includes a reflection panel, and the reflection panel is perpendicular to the first conductor sheet.

In this possible implementation, the reflection panel may change distribution of beam energy of the antenna in space.

In a possible implementation of the first aspect, a length of the antenna in a direction along the gap is greater than a length of the antenna in a direction perpendicular to the gap.

In this possible implementation, oscillation starting of the antenna (a dipole) is related only to a circumference of the cavity. Therefore, the antenna has no restriction on a resonance length of a dipole element. When the length of the antenna in the direction along the gap is greater than the length of the antenna in the direction perpendicular to the gap, the length of the antenna in the direction perpendicular to the gap is reduced. During actual application, this facilitates miniaturization of an entire AP device.

In a possible implementation of the first aspect, a length of the gap is less than half of the wavelength corresponding to the operating frequency band of the antenna.

When the length of the gap is excessively long, beam energy is dispersed. When the length of the gap is less than half of the wavelength corresponding to the operating frequency band of the antenna, a beam gain improvement effect is better.

In a possible implementation of the first aspect, there is one feed point.

According to a second aspect, this application provides an antenna. The antenna includes a first conductor sheet, a ground plane, and a feed point. The first conductor sheet includes at least two cavities. The at least two cavities are connected through a gap. One side of the first conductor sheet is connected to the ground plane, and an electrical length of each of the at least two cavities approaches half of a wavelength corresponding to an operating frequency band of the antenna. The electrical length of the cavity is a difference between a circumference of the cavity and a first overlapping length, and the first overlapping length is a length of a part connecting the cavity and the ground plane. The ground plane is grounded. The feed point is separately connected to the gap and the ground plane.

In this application, the ground plane is electrically connected to the first conductor sheet. After the feed point is powered on, the ground plane is equivalent to a mirror surface, and can reflect an electromagnetic wave and a standing wave current, which is equivalent to generating a virtual mirror-symmetrical conductor sheet at a same position on the reverse side of the first conductor sheet. When the standing wave current flows to the ground plane, it is equivalent to flowing through the ground plane in a mirroring manner and finally returning to the first conductor sheet. In this case, the electrical length of the cavity, namely, the circumference of the cavity minus the length of the overlapping part with the ground plane, approaches half of the wavelength corresponding to the operating frequency band of the antenna. In this case, when a size of the antenna is reduced, a same effect as that of the antenna provided in the first aspect of this application may also be implemented.

According to the second aspect, based on the antenna provided in the first aspect of this application, a structure of the first conductor sheet is mirrored and reduced by half, and in addition to having beneficial effects of the antenna provided in the first aspect or any possible implementation of the first aspect of this application, the antenna may further be miniaturized.

The antenna provided in the second aspect of this application has a same beneficial effect as the antenna in any one of the first aspect or the possible implementations of the first aspect in this application.

According to a third aspect, this application provides a communication device. The communication device includes the antenna according to any one of the first aspect or the possible implementations of the first aspect, and a radio frequency component coupled to the antenna.

According to a fourth aspect, this application provides a communication device. The communication device includes the antenna according to any one of the second aspect or the possible implementations of the second aspect, and a radio frequency component coupled to the antenna.

It can be learned from the foregoing technical solutions that this application has the following advantages.

The antenna includes a first conductor sheet and a feed point. The first conductor sheet includes at least two cavities, the at least two cavities are connected through a gap, a circumference of each of the at least two cavities approaches a wavelength corresponding to an operating frequency band of the antenna, and the feed point is connected to the gap. The antenna with a simple structure and a small size may generate two beams. Therefore, a wireless access point disposed with the antenna may generate strong wireless signals in two directions, and the wireless signal may cover an adjacent room. In this way, there is no need to deploy an access point in each room, and a quantity of wireless access points to be deployed is reduced.

### BRIEF DESCRIPTION OF DRAWINGS

FIG. 1 is a schematic diagram of an application scenario according to an embodiment of this application;

FIG. 2 is a schematic diagram of AP deployment according to an embodiment of this application;

FIG. 3 is a schematic diagram of a structure of an embodiment of an antenna according to an embodiment of this application;

FIG. 4 is a schematic diagram of a structure of another embodiment of an antenna according to an embodiment of this application;

FIG. 5A is a schematic diagram of a structure of another embodiment of an antenna according to an embodiment of this application;

FIG. 5B is a schematic diagram of a structure of another embodiment of an antenna according to an embodiment of this application;

FIG. 6A is a direction pattern of an embodiment of an antenna according to an embodiment of this application;

FIG. 6B is another direction pattern of an embodiment of an antenna according to an embodiment of this application;

FIG. 7 is a schematic diagram of a structure of another embodiment of an antenna according to an embodiment of this application;

FIG. 8 is a schematic diagram of a structure of another embodiment of an antenna according to an embodiment of this application;

FIG. 9 is a direction pattern of another embodiment of an antenna according to an embodiment of this application;

FIG. 10A is a schematic diagram of a structure of another embodiment of an antenna according to an embodiment of this application;

FIG. 10B is a top view of a schematic diagram of a structure of another embodiment of an antenna according to an embodiment of this application;

FIG. 10C is a schematic diagram of a structure of another embodiment of an antenna according to an embodiment of this application;

FIG. 11 is a schematic diagram of a structure of another embodiment of an antenna according to an embodiment of this application;

FIG. 12 is a schematic diagram of a structure of another embodiment of an antenna according to an embodiment of this application;

FIG. 13 is a schematic diagram of a structure of another embodiment of an antenna according to an embodiment of this application;

FIG. 14 is a direction pattern of another embodiment of an antenna according to an embodiment of this application;

FIG. 15 is a schematic diagram of deployment of an embodiment of a communication device according to an embodiment of this application; and

FIG. 16 is a schematic diagram of deployment of another embodiment of a communication device according to an embodiment of this application.

### DESCRIPTION OF EMBODIMENTS

In the specification, claims, and accompanying drawings of this application, the terms “first”, “second”, and the like are intended to distinguish between similar objects, but do not necessarily indicate a specific order or sequence. It should be understood that data termed in such a way is interchangeable in proper circumstances, so that embodiments described herein can be implemented in other orders than the order illustrated or described herein. In addition, to better describe this application, the following specific implementations provide many specific details. A person skilled in the art should understand that this application may also be implemented without some specific details. In some examples, methods, means, components, and circuits well known by a person skilled in the art are not described in detail, to highlight a main purpose of this application.

Embodiments of this application provide an antenna, to reduce a quantity of wireless access points to be deployed. This application further provides a corresponding communication device. Details are separately described below.

The following describes an application scenario of embodiments of this application by using examples.

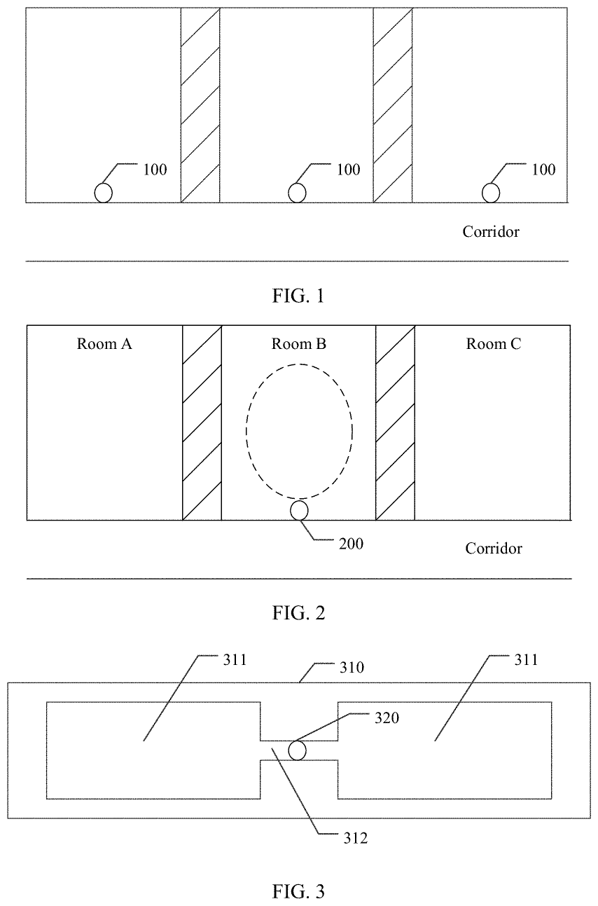

As shown in FIG. 1, in a scenario with a plurality of high-density rooms, the plurality of rooms are partitioned by walls. To provide a wireless network for these rooms, a plurality of access points 100 are deployed. The plurality of APs 100 share one wired network, and convert the wired network into a wireless network. Each AP 100 may provide a wireless signal within a specific range of a location of the AP 100.

For example, as shown in FIG. 2, there are a plurality of users in a room A, a room B, and a room C. These users use electronic devices to access an AP 200, and the AP 200 is deployed only in the room B. When the AP 200 uses an omnidirectional antenna, electromagnetic waves emitted by the omnidirectional antenna radiate to surrounding areas, and generated omnidirectional beam energy is dispersed. Due to losses caused by walls, only the user in the room B can receive strong wireless signals, and the users in the room A and the room C receive weak wireless signals.

The antenna provided in embodiments of this application is described below with reference to the foregoing application scenario.

As shown in FIG. 3, an embodiment of an antenna provided in an embodiment of this application includes a first conductor sheet 310 and a feed point 320.

The first conductor sheet 310 includes at least two cavities 311. The at least two cavities 311 are connected through a gap 312. A circumference of each of the at least two cavities 311 approaches a wavelength corresponding to an operating frequency band of the antenna. The feed point 320 is connected to the gap 312.

Optionally, the antenna may be manufactured in a metal stamping manner. A material of the first conductor sheet is metal, and may be specifically copper, stainless steel, copper foil, or the like. The first conductor sheet may be a straight sheet, or may be bent by a preset angle. The first conductor sheet is of a rectangular structure, and cavities in the first conductor sheet are of rectangular structures. The gap is also of a rectangular structure, and a size of the gap is less than a size of the cavity. For example, a length of the gap is 8 millimeters, and a length of the cavity is 20 millimeters. The material and the shape of the first conductor sheet are not limited in this embodiment of this application.

Specifically, that the circumference of the cavity approaches the wavelength corresponding to the operating frequency band of the antenna means that the circumference of the cavity is approximately equal to the wavelength corresponding to the operating frequency band of the antenna. The operating frequency band (a frequency range in which the antenna effectively operates) of the antenna is divided into a plurality of channels. During actual operation, the antenna may use any one of the channels. When different channels are used, an operating wavelength of the antenna also changes. In addition, the wavelength corresponding to the operating frequency band of the antenna is also related to a manufacturing process of the antenna. For example, when the antenna is manufactured by using a printed circuit board (printed circuit board, PCB) process, a PCB medium also affects the operating wavelength of the antenna. Therefore, in this embodiment of this application, the operating frequency band of the antenna is determined based on an actual application scenario of the antenna and the manufacturing process of the antenna. Because the wavelength corresponding to the operating frequency band of the antenna is affected by many factors, the circumference of the cavity may deviate from the wavelength corresponding to the operating frequency band of the antenna.

For example, a deviation between the circumference of the cavity and the wavelength corresponding to the operating frequency band of the antenna is less than 20%. It is assumed that the wavelength corresponding to the operating frequency band of the antenna is , and the circumference of the cavity is C. In this case:

$$\frac{\vert C - λ \vert}{λ} \times 100 \% < 20 \%$$

Depending on a change of a bandwidth or another factor of the frequency band, an upper limit of the deviation may alternatively be less than 15%, 10%, 5%, or the like.

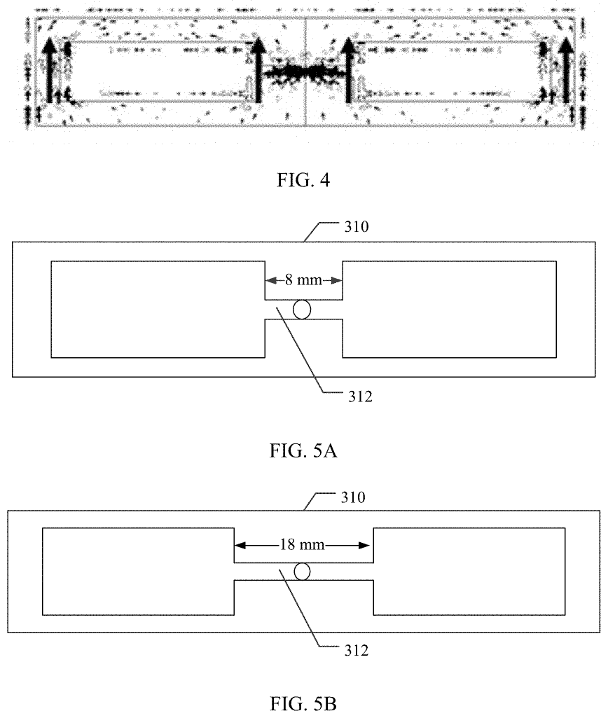

As shown in FIG. 4, when the circumference of the cavity approaches the wavelength corresponding to the operating frequency band of the antenna, the feed point may generate a standing wave current on the first conductor sheet through the gap. The standing wave current oscillates along the first conductor sheet, and maximum values of the standing wave current (where corresponding standing wave currents are referred to as maximum standing wave currents for short) are generated at two ends of the cavity, and have a same direction. Because maximum standing wave currents in the two cavities near the gap side are close to each other, the maximum standing wave currents may be considered as an equivalent array satisfying binomial distribution of “1, 2, 1”, that is, an amplitude of an oscillator of the antenna conforms to binomial distribution. Based on an array theory, after the antenna is powered on at the feed point, zero points may be formed at two ends of the first conductor sheet in a direction along the gap, to construct dual beams.

In an actual operating scenario, a channel used by the antenna may also be appropriately changed according to a requirement, and a corresponding wavelength also changes accordingly. In this case, although the circumference of each cavity of the first conductor sheet cannot be changed, a same technical effect can also be achieved, provided that the deviation between the circumference of the cavity and the wavelength of the antenna meets a threshold.

It should be understood that the feed point is a place where communication cables are electrically connected. Optionally, there is one feed point, so that the antenna can generate dual beams. To implement different quantities of beams, a quantity of feed points may also be increased accordingly. In this embodiment of this application, a case in which there is only one feed point is used for description.

Optionally, a length of the antenna in the direction along the gap is greater than a length of the antenna in a direction perpendicular to the gap. FIG. 3 is a front view of the antenna. However, in an actual application scenario of antennas, the antennas need to be deployed in different directions. A length of the gap is far greater than a width of the gap. Therefore, the direction along the gap may be understood as a direction of the length of the gap, and the direction perpendicular to the gap may be understood as a direction of the width of the gap. Oscillation starting of the antenna (a dipole) is related only to the circumference of the cavity. Therefore, the antenna has no restriction on a resonance length of a dipole element. It may be designed that the length of the antenna in the direction along the gap is greater than the length of the antenna in the direction perpendicular to the gap, and the length of the antenna in the direction perpendicular to the gap is reduced. During actual application, this facilitates miniaturization of an entire AP device.

To further improve an antenna gain, the following further describes in detail the antenna provided in embodiments of this application with reference to three implementations.

Implementation 1: The length of the gap is increased.

As shown in FIG. 5A and FIG. 5B, the length of the gap 312 is increased, so that a transverse diameter of the antenna may be increased. When the transverse diameter of the antenna becomes larger, a distance between two zero points formed on the first conductor sheet 310 also becomes longer, dual beams generated by the antenna become narrower, and beam energy is more concentrated. In this way, a beam gain of the antenna is improved.

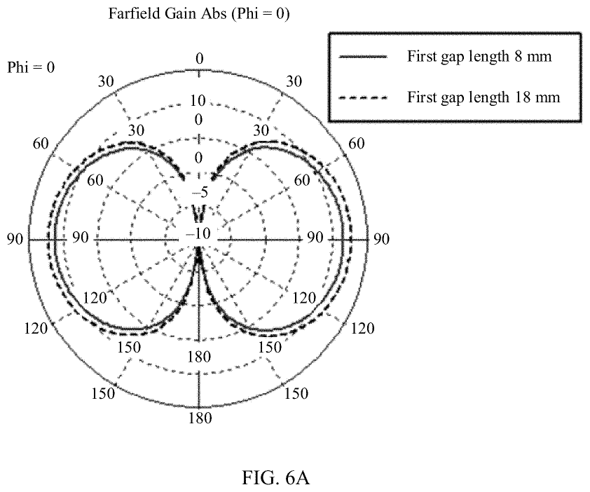

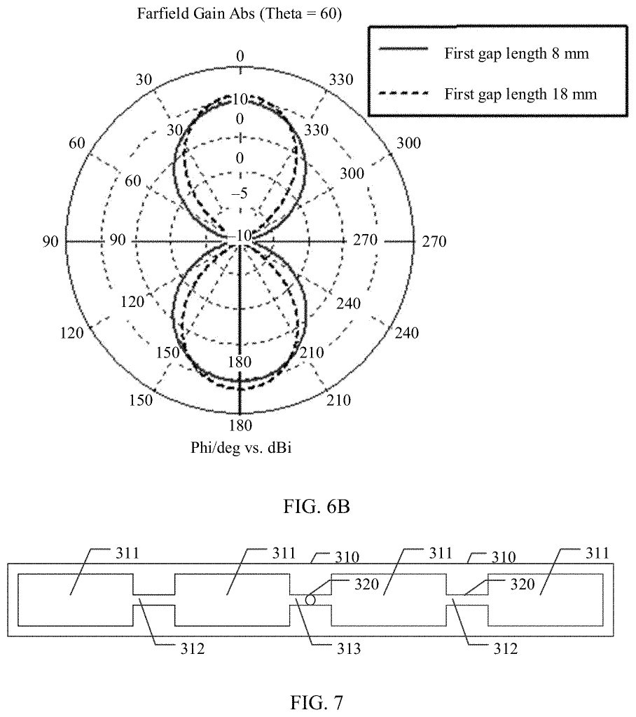

For example, as shown in FIG. 6A and FIG. 6B, in a direction pattern of an E plane (a directional plane parallel to a direction of an electric field, namely, an xoz plane or a yoz plane, also referred to as an electrical plane) of the antenna, when an angle (Phi) in an azimuth plane (horizontal plane) is 0°, it can be learned that a far-field gain (Farfield Gain Abs) of the antenna when the length of the gap is 8 mm is weaker than a far-field gain of the antenna when the length of the gap is 18 mm. Similarly, in a direction pattern of an H plane (a directional plane parallel to the direction of the electric field, namely, an xoy plane, also referred to as a magnetic plane) of the antenna, when an angle (Theta) in an elevation plane (vertical plane) is 60°, it can also be learned that the far-field gain of the antenna when the length of the gap is 8 mm is weaker than the far-field gain of the antenna when the length of the gap is 18 mm.

Optionally, although the beam gain of the antenna can be improved by increasing the length of the gap, beam energy is also dispersed when the length of the gap is excessively long. To ensure a beam gain improvement effect, the length of the gap is less than half of the wavelength corresponding to the operating frequency band of the antenna. For the wavelength corresponding to the operating frequency band of the antenna, refer to the foregoing corresponding descriptions for corresponding understanding. Because the wavelength corresponding to the operating frequency band of the antenna is approximately equal to the circumference of the cavity, it may also be understood that the length of the gap is less than half of the circumference of the cavity.

A specific value of the width of the gap is not limited in this embodiment of this application. However, during actual application, the width of the gap is related to impedance matching of the antenna. The width of the gap may be designed according to a requirement for a parameter such as the impedance matching of the antenna.

Implementation 2: A quantity of cavities is increased.

Based on a principle the same as that in Implementation 1, when the quantity of cavities is increased, the transverse diameter of the antenna may also be increased, and an increase in the diameter is far greater than an increase in the length of the gap. Therefore, the beam gain of the antenna can be further improved. There are two specific examples for increasing the quantity of cavities, and the following separately provides detailed descriptions by using Implementation 2.1 and Implementation 2.2.

Implementation 2.1: The quantity of cavities is increased through a serial connection.

For example, as shown in FIG. 7, the first conductor sheet 310 includes at least four cavities 311, the feed point 320 is connected to a middle gap 313, and the middle gap 313 is a gap 312 in the middle of a plurality of gaps 312 connecting the at least four cavities 311.

It should be understood that, after the quantity of cavities is increased, a quantity of gaps is also increased accordingly. In this case, sizes of the plurality of gaps may be designed with reference to the descriptions in Implementation 1, and effects achieved after lengths of the plurality of gaps are increased are the same.

Optionally, if the feed point 320 is specifically in the middle of the middle gap, a bandwidth of the antenna may reach a maximum, and beams generated by the antenna may be symmetrical.

A quantity N of cavities of the first conductor sheet is at least 2. When N=2, only one gap exists in the first conductor sheet, and the feed point is definitely connected to the gap. In addition, N may be an even number or an odd number greater than 2. When N is an even number, the feed point is connected to a middle gap. In this case, the antenna may generate beams of another quantity such as dual beams or four beams, and the beams are symmetrical. When N is an odd number, the middle gap may be a gap that is in a plurality of gaps of the N cavities and that is on the left side or the right side of a position closest to the middle of the first conductor sheet. This is not limited in this embodiment of this application. In this case, the antenna may generate beams of another quantity, but the beams are asymmetrical.

Implementation 2.2: The quantity of cavities is increased through a parallel connection.

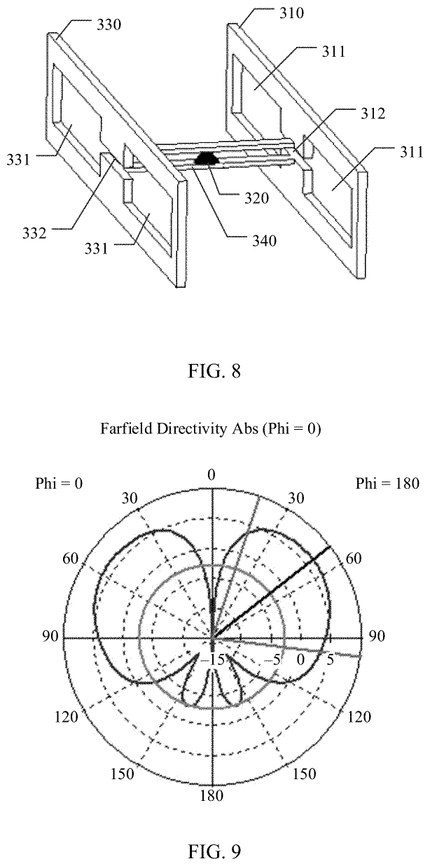

For example, as shown in FIG. 8, the antenna includes a first conductor sheet 310, a feed point 320, and a second conductor sheet 330.

The first conductor sheet 310 includes at least two cavities 311. The at least two cavities 311 are connected through a gap 312. The second conductor sheet 330 includes at least two cavities 331 connected through a gap. A circumference of each cavity 331 of the second conductor sheet 330 approaches a wavelength corresponding to an operating frequency band of the antenna. The gap 312 of the first conductor sheet 310 and the gap 332 of the second conductor sheet 330 are connected by using a feed network 340, that is, the first conductor sheet 310 and the second conductor sheet 330 are connected by using the feed network 340. The feed point 320 is disposed on the feed network 340, that is, the feed point 320 is separately connected to the gap 312 of the first conductor sheet 310 and the gap 332 of the second conductor sheet 330 by using the feed network 340.

Specifically, the feed network may be a transmission line or another conductive structure, and the feed point is disposed in the middle of the feed network. For example, the feed network includes an upper transmission line and a lower transmission line, which are respectively connected to an outer conductor and an inner conductor of the feed point. The first conductor sheet may be parallel to or substantially parallel to the second conductor sheet (where when the first conductor sheet and the second conductor sheet are substantially parallel or have an included angle, beams of another quantity may be formed). Compared with Implementation 2.1, Implementation 2.2 may make a bandwidth of the antenna wider.

It should be understood that the first conductor sheet may be completely the same as the second conductor sheet, but on the basis of a same overall structure, a quantity of cavities of the second conductor sheet may be different from a quantity of cavities of the first conductor sheet, and a size of the second conductor sheet may also be different from a size of the first conductor sheet (where for example, lengths of the gaps are different, and lengths of the cavities are different). Implementation 2.2 may be implemented on the basis of Implementation 2.1, or may be implemented on the basis of Implementation 1. Whether the first conductor sheet and the second conductor sheet are completely the same affects only a quantity or symmetry of beams generated by the antenna. This is not limited in this embodiment of this application.

Implementation 3: A reflection panel is added.

The antenna further includes a reflection panel. The reflection panel is perpendicular to the first conductor sheet. For example, the first conductor sheet is suspended above the reflection panel, and the reflection panel is a metal reflection panel. The reflection panel may change distribution of beam energy in space, so that when the antenna is used in APs, the APs can be arranged in more manners, and may be used in more deployment scenarios. For example, the APs are arranged in the middle on the top of a room or at a door of a room according to a requirement of a user. As shown in FIG. 9, a maximum radiation direction of the E plane of the antenna is changed.

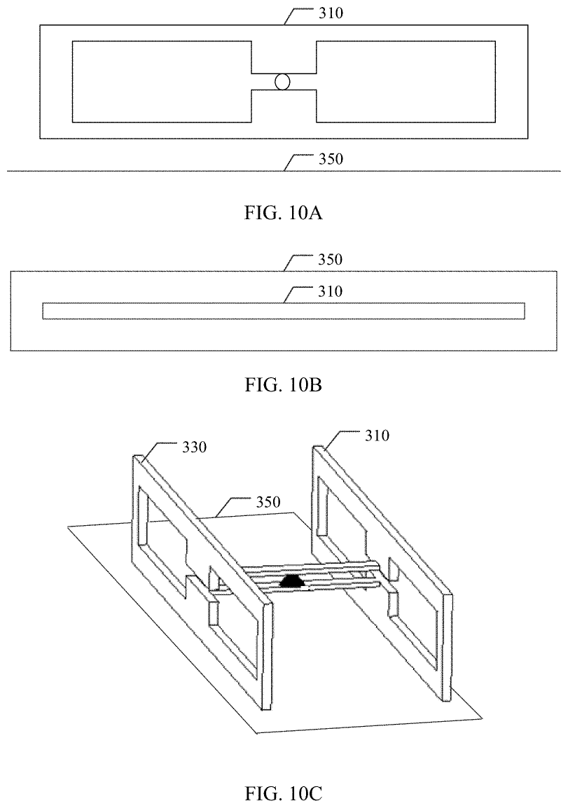

Implementation 3 may be implemented based on any one of the foregoing implementations. For example, as shown in FIG. 10A and FIG. 10B, on the basis of Implementation 1, a reflection panel 350 may be added at a position perpendicular to the first conductor sheet 310 or the second conductor sheet 330. Based on FIG. 10B, a thickness of the first conductor sheet is not limited in this embodiment of this application. In addition, a schematic diagram of adding a reflection panel in Implementation 2.1 is similar to that in Implementation 1, and details are not described herein. As shown in FIG. 10C, on the basis of Implementation 2.2, a reflection panel 350 may also be added at a position perpendicular to the first conductor sheet 310 or the second conductor sheet 330.

It can be learned from the foregoing implementations that beneficial effects achieved by embodiments of this application include one or more of the following (1) to (6).

(1) In the antenna provided in this embodiment of this application, the circumference of each of the at least two cavities approaches the wavelength corresponding to the operating frequency band of the antenna, so that on a basis that dual beams can be generated, the antenna can be manufactured by using a metal material. This eliminates impact of another medium (for example, a PCB) on the wavelength of the antenna, improves radiation efficiency, and facilitates heat dissipation.

(2) The antenna has a simple structure, a feed network is not required, and only the circumference of the cavity is limited, so that a limitation on a height or the length of the antenna is avoided. This facilitates miniaturization of an entire AP device during actual application.

(3) The quantity of cavities in the first conductor sheet is increased, so that the transverse diameter of the antenna may be increased, the distance between the two zero points formed on the first conductor sheet also becomes longer, the dual beams generated by the antenna become narrower, and the beam energy is more concentrated. In this way, the beam gain of the antenna is improved.

(4) The second conductor sheet is added, so that the transverse diameter of the antenna is increased. In this way, the beam gain of the antenna can be improved, and a quantity of beams may also be changed.

(5) The reflection panel is disposed in the direction perpendicular to the first conductor sheet, so that distribution of the beam energy in space is changed.

(6) A multiple-input multiple-output (multiple-input multiple-output, MIMO) system requires that beams generated by all antennas be basically the same. However, in this embodiment of this application, instead of two antennas separately generating one beam, one antenna generates two beams to implement dual beams. Therefore, the antenna provided in this embodiment of this application is applicable to the MIMO system.

As shown in FIG. 11, another embodiment of an antenna provided in an embodiment of this application includes a first conductor sheet 410, a ground plane (ground plane) 430, and a feed point 420.

The first conductor sheet 410 includes at least two cavities 411. The at least two cavities 411 are connected through a gap 412. One side of the first conductor sheet 410 is connected to the ground plane 430. An electrical length of each of the at least two cavities 411 approaches half of a wavelength corresponding to an operating frequency band of the antenna. The electrical length of the cavity 411 is a difference between a circumference of the cavity 411 and a first overlapping length, and the first overlapping length is a length of a part connecting the cavity 411 and the ground plane 430. The ground plane 430 is grounded. The feed point 420 is separately connected to the gap 412 and the ground plane 430.

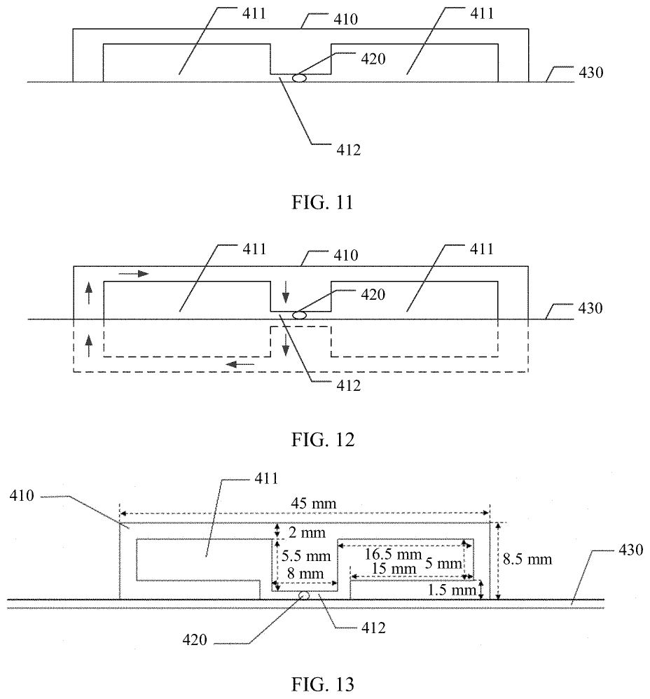

Specifically, as shown in FIG. 12, the ground plane 430 is electrically connected to the first conductor sheet 410. After the feed point 420 is powered on, the ground plane 430 is equivalent to a mirror surface, and reflects an electromagnetic wave and a standing wave current, which is equivalent to generating a virtual mirror-symmetrical conductor sheet at a same position on a reverse side of the first conductor sheet 410. When the standing wave current flows to the ground plane 430, it is equivalent to flowing through the ground plane 430 in a mirroring manner and finally returning to the first conductor sheet 410. In this case, the electrical length of the cavity 411, namely, the circumference of the cavity 411 minus the length of the overlapping part with the ground plane 430, approaches half of the wavelength corresponding to the operating frequency band of the antenna. In this case, when a size of the antenna is reduced, a same effect as that of the antenna shown in FIG. 3 may also be achieved.

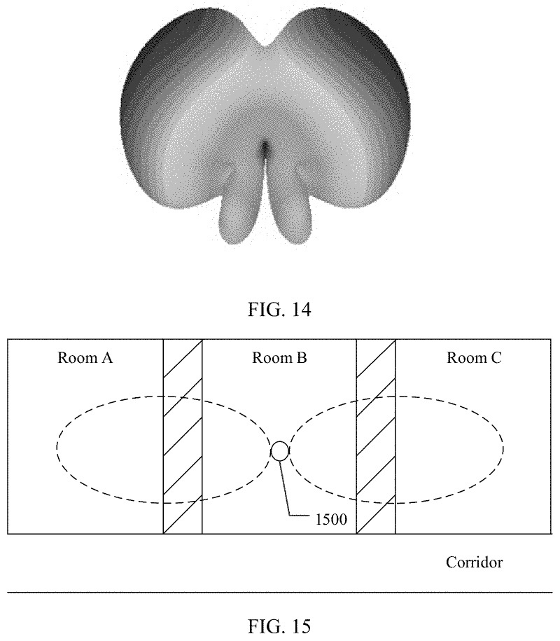

For example, as shown in FIG. 13, the antenna is used in a 5 GHz frequency band (about 5 GHz to 5.9 GHz) whose center frequency is 5.5 GHz. When the antenna is designed, 54.5 millimeters (mm) are used as the wavelength corresponding to the operating frequency band of the antenna. For better supportability of the antenna, the cavity 411 is connected to the ground plane 430 through a metal part in the first conductor sheet 410, and the feed point 420 is located in the middle of the gap 412. It can be learned with reference to FIG. 13 that, the first conductor sheet 410 has a length of 45 mm and a width of 8.5 mm; the cavity 411 has a length of 16.5 mm and a width of 5 mm; and the gap 412 has a length of 8 mm and a width of 1.5 mm. In addition, a length of the part that is of the cavity 411 and that is connected to the ground plane 430 through the metal part in the first conductor sheet 410 is 15 mm, a distance between the gap 412 and an upper boundary of the cavity 411 is 5.5 mm, and a distance between an upper boundary of the first conductor sheet 410 and the upper boundary of the cavity 411 is 2 mm. In this case, it may be determined that the electrical length of the cavity 411 is 26.5 mm, which is close to half of the wavelength corresponding to the operating frequency band of the antenna, namely, 27.25 mm. After the antenna is put into actual use, a three-dimensional direction pattern shown in FIG. 14 may be obtained.

In addition, to miniaturize the antenna, when the electrical length of the cavity remains unchanged, the length of the cavity needs to be larger, and the width of the cavity needs to be smaller. However, if the width of the cavity is excessively small, a bandwidth of the antenna also becomes narrow. Therefore, the width of the cavity needs to be reduced within a range allowed by the bandwidth of the antenna. However, the ground plane is disposed in the antenna provided in this embodiment of this application, and the width of the cavity is also mirrored. Therefore, a minimum width of the cavity within the range allowed by the bandwidth of the antenna can be halved, so that antenna miniaturization is further implemented without changing the bandwidth of the antenna.

Optionally, a deviation between the electrical length of the cavity and half of the wavelength corresponding to the operating frequency band of the antenna is less than 10%.

Optionally, the first conductor sheet includes at least four cavities. The feed point is connected to a middle gap, and the middle gap is a gap in the middle of a plurality of gaps connecting the at least four cavities.

Optionally, the antenna further includes a second conductor sheet. The second conductor sheet includes at least two cavities connected through a gap. One side of the second conductor sheet is connected to the ground plane. An electrical length of each cavity of the second conductor sheet approaches half of the wavelength corresponding to the operating frequency band of the antenna. The electrical length of the cavity of the second conductor sheet is a difference between a circumference of the cavity of the second conductor sheet and a second overlapping length, and the second overlapping length is a length of a part connecting the cavity of the second conductor sheet and the ground plane. The gap of the first conductor sheet and the gap of the second conductor sheet are connected by using a feed network, and a feed point is disposed on the feed network.

Specifically, compared with the antenna shown in FIG. 8, in this case, an inner conductor of the feed point is connected to an upper transmission line, and an outer conductor of the feed point is connected to the ground plane instead of being connected to a lower transmission line. Optionally, the antenna further includes a reflection panel. The reflection panel is perpendicular to the first conductor sheet, and the reflection panel may be considered as a ground plane not connected to the first conductor sheet. In this case, a preset distance exists between the reflection panel and the ground plane. When a size of an AP in which the antenna is used is small, a size of the ground plane is also small accordingly. If a requirement of a user cannot be met when beam distribution of the antenna is changed by using the ground plane of a small size, a reflection panel of a larger size may be disposed outside the AP.

Optionally, a length of the antenna in a direction along the gap is greater than a length of the antenna in a direction perpendicular to the gap.

Optionally, a length of the gap is less than half of the wavelength corresponding to the operating frequency band of the antenna.

Optionally, there is one feed point.

For other details and implementations of the antenna provided in this embodiment of this application, refer to corresponding content of the antenna in the embodiments in FIG. 3 to FIG. 10C for understanding. A difference lies only in that the ground plane is additionally disposed in the antenna provided in this embodiment of this application, and a structure of the first conductor sheet or the second conductor sheet is mirrored and reduced by half. Details are not described herein again. In addition to achieving the beneficial effects of the antenna in the embodiments in FIG. 3 to FIG. 10C, this embodiment further miniaturizes the antenna.

The foregoing describes the antenna provided in embodiments of this application. The following describes, with reference to the foregoing antenna, a communication device provided in embodiments of this application.

As shown in FIG. 15, an embodiment of a communication device provided in an embodiment of this application includes the antenna described in the embodiments in FIGS. 3 to FIG. 10C, or the antenna described in the embodiments in FIG. 11 to FIG. 14, and a radio frequency component coupled to the antenna. The communication device achieves same beneficial effects as the foregoing antenna.

The communication device is an AP device or another communication device that can provide a wireless network access service, for example, a wireless router or a base station. The radio frequency component may be specifically a radio frequency circuit. When the communication device is deployed, for example, in the scenario shown in FIG. 2, there are users in the room A, the room B, and the room C, and these users use electronic devices to access a wireless network. Although an AP 1500 is deployed only in the room B, when the AP 1500 uses the antenna provided in embodiments of this application, the antenna may generate beams that are formed in two directions and that are represented by dashed lines in the figure. The two beams are distributed in 180° directions. Although the AP 1500 is deployed in the room B, the two beams generated by the AP 1500 are respectively directed towards the room A and the room C. Therefore, even if there are walls blocking between the room B and the room A and the room C, strength of wireless signals in the room A and the room C can still meet a requirement of the user. Although a beam generated by the AP 1500 is not directly directed towards the room B, because there is no wall blocking in the room B, strength of wireless signals in the room B can also meet a requirement of the user. Therefore, for the three rooms, only one AP 1500 needs to be deployed.

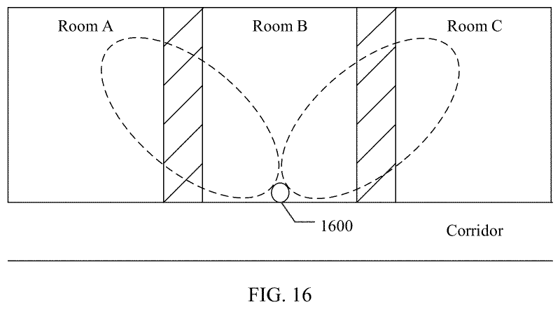

In addition, the reflection panel is added at a position perpendicular to the first conductor sheet or the second conductor sheet, and/or the first conductor sheet is connected to the ground plane, to change distribution of beam energy in space. Therefore, the communication device may be deployed in another manner. A position and a direction of the communication device are adjusted, so that the beam may be radiated to more rooms as much as possible. As shown in FIG. 16, a reflection panel is added, so that an AP 1600 may be deployed at a door of the room B. This is more convenient for deployment by construction personnel, to meet more deployment requirements.

For understanding of the antenna in the communication device provided in this embodiment of this application, refer to corresponding content in the foregoing embodiments of the antenna. Details are not described herein again.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In several embodiments provided in this application, it should be understood that the disclosed system, apparatus, and method may be implemented in other manners. For example, the described apparatus embodiments are merely examples. For example, division into the units is merely logical function division and may be other division during actual implementation. For example, a plurality of units or components may be combined or integrated into another system, or some features may be ignored or may not be performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separated, and parts displayed as units may or may not be physical units, that is, may be located in one position, or may be distributed on a plurality of network units. Some or all of the units may be selected according to actual requirements to achieve objectives of the solutions of the embodiments.

In addition, functional units in embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in a form of a software functional unit and sold or used as an independent product, the integrated unit may be stored in a computer-readable storage medium. Based on such an understanding, technical solutions of this application essentially, or a part contributing to the current technology, or all or some of the technical solutions may be implemented in a form of a software product. The computer software product is stored in a readable storage medium and includes several instructions for instructing a computer device (which may be a personal computer, a server, a network device, or the like) to perform all or some of the steps of the method in embodiments of this application. The storage medium includes any medium that can store program code, such as a USB flash drive, a removable hard disk, a read-only memory (ROM, read-only memory), a random access memory (RAM, random access memory), a magnetic disk, or an optical disc.

1.-17. (canceled)

8. An antenna, comprising:
a first conductor sheet; and
a feed point,
wherein the first conductor sheet comprises at least two cavities, the at least two cavities are connected through a gap, and a respective circumference of each of the at least two cavities approaches a wavelength corresponding to an operating frequency band of the antenna, and
wherein the feed point is connected to the gap.

19. The antenna according to claim 18, wherein a deviation between the respective circumference of each of the at least two cavities and the wavelength corresponding to the operating frequency band of the antenna is less than 20%.

20. The antenna according to claim 18, wherein the first conductor sheet comprises at least four cavities, the feed point is connected to a middle gap, and the middle gap in a middle of a plurality of gaps connecting the at least four cavities.

21. The antenna according to claim 18, wherein the antenna further comprises a second conductor sheet,
wherein the second conductor sheet comprises second at least two cavities that are connected through a second gap, and a second respective circumference of each of the second at least two cavities of the second conductor sheet approaches the wavelength corresponding to the operating frequency band of the antenna, and
wherein the gap of the first conductor sheet and the second gap of the second conductor sheet are connected by using a feed network.

22. The antenna according to claim 18, wherein the antenna further comprises a reflection panel, and the reflection panel is perpendicular to the first conductor sheet.

23. The antenna according to claim 18, wherein a first length of the antenna in a first direction along the gap is greater than a second length of the antenna in a second direction perpendicular to the gap.

24. The antenna according to claim 18, wherein a length of the gap is less than half of the wavelength corresponding to the operating frequency band of the antenna.

25. The antenna according to claim 18, wherein there is one feed point.

26. An antenna, comprising:
a first conductor sheet,
a ground plane, and
a feed point,
wherein the first conductor sheet comprises at least two cavities, and the at least two cavities are connected through a gap,
wherein a first side of the first conductor sheet is connected to the ground plane, a respective electrical length of each of the at least two cavities approaches half of a wavelength corresponding to an operating frequency band of the antenna, the respective electrical length of each of the at least two cavities is a difference between a respective circumference of each of the at least two cavities and a first overlapping length, and the first overlapping length is of a part connecting each of the at least two cavities and the ground plane,
wherein the ground plane is grounded, and
wherein the feed point is separately connected to the gap and the ground plane.

27. The antenna according to claim 26, wherein a deviation between the respective electrical length of each of the at least two cavities and half of the wavelength corresponding to the operating frequency band of the antenna is less than 10%.

28. The antenna according to claim 26, wherein the first conductor sheet comprises at least four cavities, the feed point is connected to a middle gap, and the middle gap is in a middle of a plurality of gaps connecting the at least four cavities.

29. The antenna according to claim 26, wherein the antenna further comprises a second conductor sheet,
wherein the second conductor sheet comprises second at least two cavities that are connected through a second gap,
wherein a second side of the second conductor sheet is connected to the ground plane, and a second respective electrical length of each of the second at least two cavities of the second conductor sheet approaches half of the wavelength corresponding to the operating frequency band of the antenna, and
where the gap of the first conductor sheet and the second gap of the second conductor sheet are connected by using a feed network.

30. The antenna according to claim 26, wherein the antenna further comprises a reflection panel, and the reflection panel is perpendicular to the first conductor sheet.

31. The antenna according to claim 26, wherein a first length of the antenna in a first direction along the gap is greater than a second length of the antenna in a second direction perpendicular to the gap.

32. The antenna according to claim 26, wherein a length of the gap is less than half of the wavelength corresponding to the operating frequency band of the antenna.

33. The antenna according to claim 26, wherein there is one feed point.

34. A communication device, comprising:
an antenna, and
a radio frequency component coupled to the antenna, the antenna including a first conductor sheet and a feed point,
wherein the first conductor sheet comprises at least two cavities, the at least two cavities are connected through a gap, and a respective circumference of each of the at least two cavities approaches a wavelength corresponding to an operating frequency band of the antenna, and
wherein the feed point is connected to the gap.

35. The communication device according to claim 34, wherein a deviation between the respective circumference of each of the at least two cavities and the wavelength corresponding to the operating frequency band of the antenna is less than 20%.

36. The communication device according to claim 34, wherein the first conductor sheet comprises at least four cavities, the feed point is connected to a middle gap, and the middle gap in a middle of a plurality of gaps connecting the at least four cavities.

37. The antenna according to claim 34, wherein the antenna further comprises a second conductor sheet,
wherein the second conductor sheet comprises second at least two cavities that are connected through a second gap, and a second respective circumference of each of the second at least two cavities of the second conductor sheet approaches the wavelength corresponding to the operating frequency band of the antenna, and
wherein the gap of the first conductor sheet and the second gap of the second conductor sheet are connected by using a feed network.
